(19) United States
(12) Patent Application Publication
(10) Pub. No.: US 2013/0068857 A1
(43) Pub. Date: Mar. 21, 2013

(54) PRESSURE WASHER SPRAY GUARD

(71) Applicant: James Gray Hite, Greenville, NC (US)

(72) Inventor: James Gray Hite, Greenville, NC (US)

(73) Assignee: James Gray Hite, Greenville, NC (US)

(21) Appl. No.: 13/236,649

(22) Filed: Sep. 20, 2011

(51) Int. Cl. B05B 15/04

(52) U.S. Cl. 239/288

(57) ABSTRACT

A pressure washer for dispensing water and/or another liquid, such as chemicals, with a relatively high pressure jet or spray, has an optional wand for optimally directing the jet or spray from the nozzle, in which the invention is a spray guard, preferably in the form of an open-sided cone, with the nozzle attached at an apex of the cone, with the bottom of the cone being open for allowing the jet or spray to be dispensed for cleaning or for washing a surface or object.

### CROSS REFERENCE TO RELATED APPLICATIONS

Reference is made hereby to Provisional Patent Application No. 61/383,863 filed Sep. 17, 2010 to Hite, which is specifically made a part of this application.

US Patent Documents

| | | |
|---|---|---|
| 6,334,578 | January 2002 | House |
| 6,679,438 | January 2004 | Didlo |
| 6,889,914 | May 2005 | Herhold |
| 7,063,275 | June 2006 | Byron |

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APPENDIX

Not Applicable

### BACKGROUND OF THE INVENTION

In the field of pressure washing, such as with pressurized water and/or chemicals, a high pressure spray may present a hazard to an operator and/or to the surface being washed. While operators are often trained to minimize such problems, problems still arise, especially with operators who have not been trained, or have not been adequately trained.

Masonry, concrete, and other solid surfaces are cleaned with both mechanical and chemical methods, often with a combination of both. Mechanical cleaning, which may include chemical cleaning, is often accomplished with the use of pressure washers which spray water or a liquid mixture under high pressure through a flexible hose and metal tube fitted with a trigger valve and discharge nozzle, or “wand”.

High pressure washing with a nozzle emitting pressurized liquid, often referred to as “spray washing” or “power washing”, is frequently the best, and in some cases, the only way to adequately clean some surfaces. However, many surfaces, such as some types of masonry, or decorative finishes, may be permanently damaged by such cleaning, if not properly done.

There is also a very considerable risk to the operator and/or bystanders, since the liquid may be emitted at a velocity that could cause considerable injury to persons who come into direct contact with it, and may contain possibly harmful chemicals.

According to the Consumer Product Safety Commission, an agency of the Federal Government, in 2004 an estimated 3,747 Americans needed hospital care for pressure washer injuries. Serious or even fatal injuries can result from the improper use of pressure washing equipment.

Such injuries tend to be more severe with increasing proximity to the discharge nozzle, since the spray from a pressure washer is more concentrated and energetic there. The primary method for preventing damage to surfaces, and especially to persons operating or otherwise exposed to a discharge from a discharge nozzle, is to avoid the danger by operation at some distance from the discharge nozzle.

Injuries to operators or other persons can be minimized by minimizing the risk of discharges from a nozzle being directed at such a person accidentally, such as when the wand is dropped or otherwise misdirected, and especially being directed at a person in close proximity to the nozzle.

During the pressure washing operation, it may be difficult for the operator to know if the finish of the surface being cleaned is being damaged, as the liquid under pressure occludes and changes the natural appearance of the surface. Damage may become apparent only after it is done, and in the case of many material finishes, such as with masonry, is not repairable without removal and reconstruction.

U.S. Pat. No. 6,334,578 to House, January 2002, discloses a segmented spray hood, which optimally provides for containing agricultural chemicals in a vehicle drawn by a tractor or similar equipment. The '578 patent does not anticipate observing the surface or object so treated, so does not include an open cone for observation of results by an operator, or preventing proximal damage from a high energy fluid stream. The '578 patent does not in any way anticipate protecting operators and surfaces from pressurized streams of fluids.

U.S. Pat. No. 6,679,438 to Didlo, January 2004, discloses a hooded pressurized wand based fluid delivery system, and is intended to be held close to a surface for delivering agricultural chemicals to plants. The stated purpose is to provide an easily storable, and therefore relatively fragile, clear shield for the application of such chemicals. The '438 patent does not anticipate use in an open environment, so does not include an open cone for observation of results by an operator, and while the shield is transparent, it is believed that the chemicals will occlude the interior, and a clear shield is useful only for seeing that the chemicals are being applied. The '438 patent does not in any way anticipate protecting operators and surfaces from pressurized streams of fluids.

U.S. Pat. No. 6,889,914 to Herhold, May 2005, discloses a a guarded high pressure spray device for cleaning and spray washing, but is designed to be included in an encompassing cuff, and so does not allow general purpose cleaning, so does not allow the operator to examine the object or surface being sprayed, and further is meant to be held against an object at a fixed distance, rather than merely establishing a minimal distance as in the present invention.

U.S. Pat. No. 7,063,275, June 2006, to Byron, discloses a closed hood for containment within a safety enclosure for cleaning with a pressurized fluid. The '275 patent does not anticipate use in an open environment, such as in pressure washing, so does not rely on an open cone construction to allow operator observation of results, and does not anticipate protecting operators or surfaces from pressurized streams of fluids.

There are multiple references cited in prior publications, including those above, but all except those explained above relate to, for example, spray diffusers, regulators, pressure relief means, root feeders, cleaning and vacuuming systems, auxiliary fluid supplies, such as for mixing, special cleaning accessories, automatic on-off systems, and the like. The inventor specifically disclaims any connection with such inventions, since the inventor's claims are to a protective shield for protection of personnel and objects, such objects being sprayed with a high pressure fluid discharge. The inventor has narrowed the references, which, when relevant, have been found only in US Patents, to those which the inventor feels have some connection, even if tenuous, with the purpose of this invention. The inventor sincerely hopes the references listed will be helpful to the Examiner and the public, but has not included references which the inventor feels have no real connection with this invention. It is further believed that the patents explained above are the only truly relevant references for this invention.

There is a long felt, unmet need for a pressure washer spray guard that provides protection from direct, proximal exposure to a nozzle jet output other of paint or other specialized uses, both for the protection of an operator and bystanders, and for protection of surfaces that might be damaged by a relatively close proximity of a pressure washer nozzle output, and further allows the visual inspection of a surface or object as it is being washed or cleaned.

### BRIEF SUMMARY OF THE INVENTION

A spray guard, as generally defined in class 239, subclass 288 of the US Patent Classification system, in the form of a substantially open-sided cone, with an apex of the cone connected to a spray nozzle and a bottom of the cone being open, inhibits the spray from being emitted in close proximity to objects that might be harmed by the spray, such as relatively delicate surfaces, or people.

The spray guard is sturdy enough to withstand rough treatment by an operator, but is substantially open so that an operator may see what is being cleaned, and how effective such cleaning may be.

Often, when unskilled operators such as homeowners use pressure washing equipment, a difficult-to-clean surface may induce the operator to move the nozzle toward the object to be cleaned, and may thereby result in damage to the object being cleaned, or even cause a highly concentrated spray to reflect off a surface in a hazardous manner. The present invention prevents or inhibits such actions.

Further, holding the discharge nozzle too close to an object may cause the density of the spray at that distance to obscure an impact point of such discharge and unnoticed damage to a surface may result, as discussed before.

Also, if a wand having a discharge nozzle is dropped or otherwise mishandled, the nozzle may be deployed in a direction and at a distance that could cause serious damage to a person or surface. By incorporating the spray guard of the present invention, the operator or a surface being cleaned is inhibited from exposure at a close proximity to a discharge point of a spray nozzle, and the more serious consequences of such events can be avoided or minimized.

### BRIEF DESCRIPTION OF THE SEVERAL VIEWS OF THE DRAWING

FIG. 1 is an exploded isometric view of the invention, together with a partial view of the equipment it is attached to.

FIG. 2 is a side view of the invention, together with a partial view of the equipment it is attached to.

FIG. 3 is an exploded partial view of the invention, together with a more detailed view of the parts of the equipment it is attached to.

### DETAILED DESCRIPTION OF THE INVENTION

The descriptions herein disclose a best mode of exercising the invention, in the opinion and intent of applicant herein.

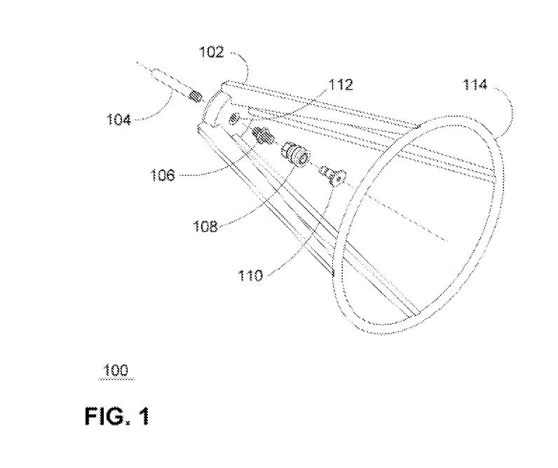

In FIG. 1 100, a best mode of the invention, the spray guard of this invention is shown in an isometric view, with the spray guard 102 in a position as it might be found in use, and an exploded partial view of the equipment it is to be attached to. Wand 104 (shown in partial view only) will be inserted in the spray guard 102 from the outside of spray guard 102 into bushing 112. Coupling piece 106 will also be inserted in bushing 112 from inside the spray guard 102. Nozzle coupling 108 is then connected to coupling piece 106, and nozzle aperture 110 will then be inserted into nozzle coupling 108. In this way the spray guard is attached to wand 104, and is ready for use. A bottom of spray guard 102 is disclosed, and comprises a ring 114. Spray guard 102 may be of any desired length and diameter, as the pressure, surface sensitivity of objects, or danger to persons may make desirable or may require, and is optimally made of plastic or similar light, durable, sturdy material.

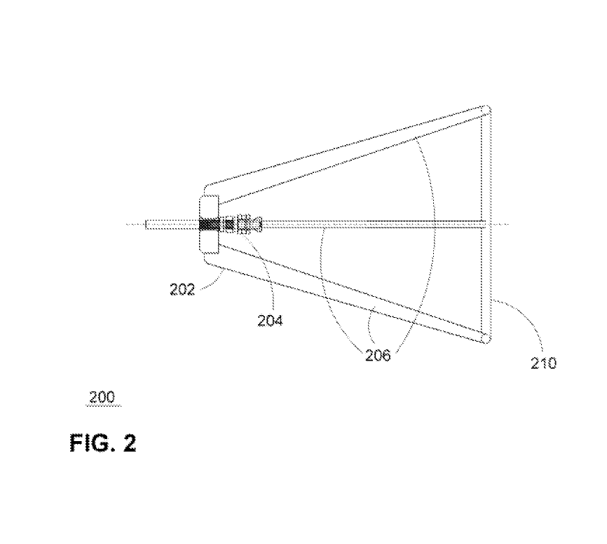

In FIG. 2 200 the completed spray equipment 204 is shown with spray guard 202 attached, in a side view. Struts 206 are disclosed with their connections to a cone bottom 210 of said spray guard 202, said bottom 210 comprising a ring 114 of FIG. 1.

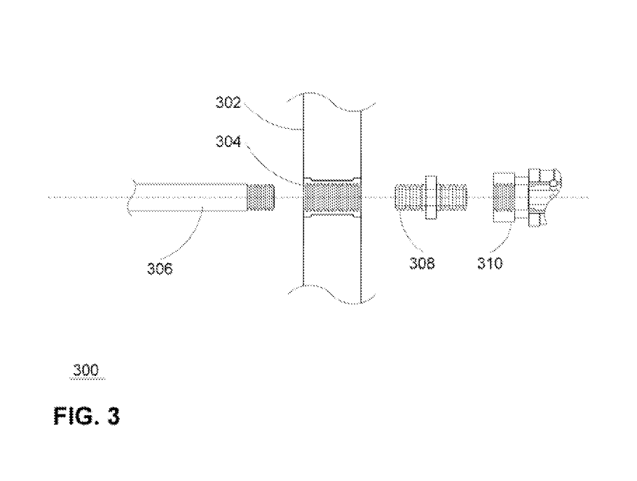

In FIG. 3 300 a more detailed partial view of the assembled spray equipment with the spray guard of this invention is shown; with wand 306 in position for insertion in bushing 304 of spray guard 302 (cut away view only), and coupling piece 308 in position for insertion into bushing 304 and for being itself inserted into nozzle coupling 310. The spray nozzle that will be inserted into nozzle coupling 310 is not shown, only those pieces coupling directly to the spray guard 302 of the invention are relevant in this view.

I claim:

1. A pressure washer for dispensing water or another liquid, such as chemicals, with a relatively high pressure jet or spray emitted from a nozzle on said washer, and with an optional wand for optimally directing said jet or spray from said nozzle, wherein the invention comprises:
a spray guard, preferably in the form of an open-sided cone, with said nozzle attached at an apex of said cone, a bottom of said cone being open for allowing said jet or spray to be dispensed for cleaning or for washing a surface or object.

2. The spray guard of claim 1, further comprising a bushing through said apex of said cone for facilitating a firm attachment of said spray guard to said wand and/or nozzle.

3. The spray guard of claim 1, further comprising a hoop or ring around a bottom of said cone of said spray guard for further preventing a close proximity to said jet or spray by an operator or an object or surface being washed or cleaned.

4. The spray guard of claim 1, further comprising a strut along a side of said cone forming said spray guard.

5. The spray guard of claim 1, further comprising the spray guard being formed primarily of plastic or similar light, durable, sturdy material.

6. The spray guard of claim 1, further being of an arbitrary length and diameter to provide an optimal zone of protection for arbitrary pressures and velocities.

7. A pressure washer for dispensing water or another liquid, such as chemicals, with a relatively high pressure jet or spray emitted from a nozzle on said washer, and with a wand for optimally directing said jet or spray from said nozzle, wherein the invention comprises:
a spray guard, preferably in the form of an open-sided cone, with said wand attached to said spray guard on an outside of said cone, and said nozzle attached on an inside of said cone, both said wand and said nozzle at an apex of said cone, a bottom of said cone being open for allowing said jet or spray to be dispensed for cleaning or for washing a surface or object.

8. The spray guard of claim 7, further comprising a bushing through said apex of said cone for facilitating a firm attachment of said spray guard to a wand and/or a nozzle.

9. The spray guard of claim 7, further comprising a hoop or ring around a bottom of said cone of said spray guard to further prevent a close proximity to said jet or spray by an operator or an object or surface being washed or cleaned.

10. The spray guard of claim 7, further comprising a strut along a side of said cone forming said spray guard.

11. The spray guard of claim 7, further comprising said spray guard being formed primarily of plastic or similar light, durable, sturdy material.

12. The spray guard of claim 7, further being of an arbitrary length and diameter to provide an optimal zone of protection for arbitrary pressures and velocities.

13. A pressure washer for dispensing water or another liquid, such as chemicals, with a relatively high pressure jet or spray emitted from a nozzle on said washer, and with an optional wand for optimally directing said jet or spray from said nozzle, wherein the invention comprises:
a spray guard, preferably in the form of an open-sided cone, with said nozzle attached at an apex of said cone, a bottom of said cone being open for allowing said jet or spray to be dispensed for cleaning or for washing a surface or object, and said spray guard with said cone further being comprised of an open structure with a bushing for making connections to both an exterior and an interior of said cone so as to facilitate the passage of a pressurized fluid from outside of said cone for dispensing said fluid from within said cone.

14. The spray guard of claim 13, further comprising a bushing through said apex of said cone for facilitating a firm attachment of said spray guard to a wand and/or a nozzle.

15. The spray guard of claim 13, further comprising a hoop or ring around a bottom of said cone of said spray guard for preventing a close proximity to said jet or spray by an operator or an object or surface being washed or cleaned.

16. The spray guard of claim 13, further comprising a strut along a side of said cone forming said spray guard.

17. The spray guard of claim 13, further comprising the spray guard being formed primarily in some type of plastic or similar light, durable, sturdy material.

18. The spray guard of claim 13, further being of an arbitrary length and diameter to provide an optimal zone of protection for arbitrary pressures and velocities.
